(19) United States
(12) Patent Application Publication
(10) Pub. No.: US 2007/0150760 A1
(43) Pub. Date: Jun. 28, 2007

(54) Reducing the amount of memory contents saved to non-volatile storage

(76) Inventor: Dan H. Nowlin, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/317,506

(22) Filed: Dec. 22, 2005

(51) Int. Cl. G06F 1/00

(52) U.S. Cl. 713/300

(57) ABSTRACT

In some embodiments a driver allocates non-paged memory in response to initiation of a suspended state operation of a system, builds a memory map of allocated memory, writes an address of the memory map. A basic input/output system (BIOS) reads the memory map, writes the read memory map to a non-volatile storage, writes memory contents to the non-volatile storage, skipping memory regions in response to the memory map, and puts the system into a suspended state after writing the contents of memory to the non-volatile storage. Other embodiments are described and claimed.

### RELATED APPLICATIONS

This application is related to U.S. patent application Ser. No. 10/644,432 entitled “Operational State Preservation in the Absence of AC Power”, filed on Aug. 19, 2003.

This application is also related to U.S. patent application Ser. No. 10/660,273 entitled “BIOS for Saving and Restoring Operational State in the Absence of AC Power”, filed on Sep. 10, 2003.

### TECHNICAL FIELD

The inventions generally relate to reducing the amount of memory contents saved to non-volatile storage.

### BACKGROUND

Advances in integrated circuits and microprocessor technologies have made possible the availability of computing devices, such as personal computers, with computing power that was once reserved for “main frames”. As a result, increasingly computing devices, such as personal computers, are being used for a wide array of computations, and often, “important” computations.

However, computing devices, such as personal computers, are still being provided without integral backup power support. Further, unlike their server brethrens, typically, supplemental external backup power supports are seldom employed. Thus, whenever the power supply fails, these computing devices go into an un-powered state, and the system states are lost.

For those computing devices endowed with power management implemented in accordance with the Advanced Configuration and Power Interface (ACPI) (jointly developed by Hewlett Packard, Intel, et al), the computing devices are said to be in the “un-powered” G3 state.

Moreover, when power is restored, and a user presses the power button of the computing device, the user typically gets a number of messages from the operating system (OS) of the computing device. Unfortunately, many of these messages are understood by sophisticated users only. Examples of these messages include asking the user whether the user desires to boot the computing device into a safe mode, have the disk drive scanned, and so forth.

If acceptance of computing devices, such as personal computers, is to continue to expand, and the computing devices are to be used by more and more users for an increasing variety of applications, such as “entertainment” applications, it is necessary for their usability, availability, and/or reliability to continue to improve. Thus, a need exists to improve the ability of a computing device, such as a personal computer, to handle power failures.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates an overview of a system incorporated with the teachings of one embodiment of the present invention, including a BIOS equipped to save a persistent copy of the system state when the system suspends to memory;

FIG. 2a illustrates the operational states of the system of FIG. 1, in accordance with one embodiment, including the suspended to memory state with a persistent copy of the system state saved;

FIG. 2b illustrates one embodiment of the power supply of FIG. 1 in further details, including a monitor for monitoring presence/absence of AC and a DC power source;

FIG. 2c illustrates an example article having programming instructions implementing all or the relevant portions of the BIOS of FIG. 1, in accordance with one embodiment;

FIG. 2d illustrates an example wake event configuration register of FIG. 1, in accordance with one embodiment;

FIG. 3a illustrates one embodiment of the relevant operation flow of the system to suspend the system to memory in responding to an AC absence condition, while operating in an active state, including the BIOS intervening to save a persistent copy of the system state;

FIG. 3b illustrates one embodiment of the relevant operation flow of the system in responding to an AC absence condition, while BIOS is saving a persistent copy of the system state as part of a suspend process initiated due to a reason other than AC absence;

FIG. 3c illustrates one embodiment of the relevant operation flow of the system in responding to an AC absence condition, while the system is suspended to memory due to a reason other than AC absence;

FIG. 4 illustrates one embodiment of the relevant operation flow of the system to resume the system in an active state, in responding to an AC re-presence condition, while operating from the backup power source in a suspended to memory state; and

FIG. 5 illustrates one embodiment of the relevant operation flow of the system to cold start and reset the system to an active state, in responding to an AC re-presence condition, while operating in an un-powered state, including conversion to a resume process employing the persistent copy of the saved system state if available.

FIG. 6 illustrates saving memory to non-volatile storage according to some embodiments of the inventions.

FIG. 7 illustrates restoring memory contents from a non-volatile storage according to some embodiments of the inventions.

### DETAILED DESCRIPTION

Some embodiments of the inventions relate to reducing the amount of memory contents saved to non-volatile storage

Some embodiments relate to reducing the amount of memory saved to non-volatile storage during a hibernate operation.

In some embodiments a driver allocates non-paged memory in response to initiation of a suspended state operation of a system, builds a memory map of allocated memory, writes an address of the memory map. A basic input/output system (BIOS) reads the memory map, writes the read memory map to a non-volatile storage, writes memory contents to the non-volatile storage, skipping non-used memory regions as detailed in the memory map, and puts the system into a suspended state after writing the contents of used memory to the non-volatile storage.

Embodiments of the present invention include but are not limited to method for saving a persistent copy of system state of a system when AC fails, BIOS equipped to facilitate practice of the method, power supply equipped to signal AC failure, and components, circuit boards or devices endowed with all or portions of the BIOS and the power supply.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

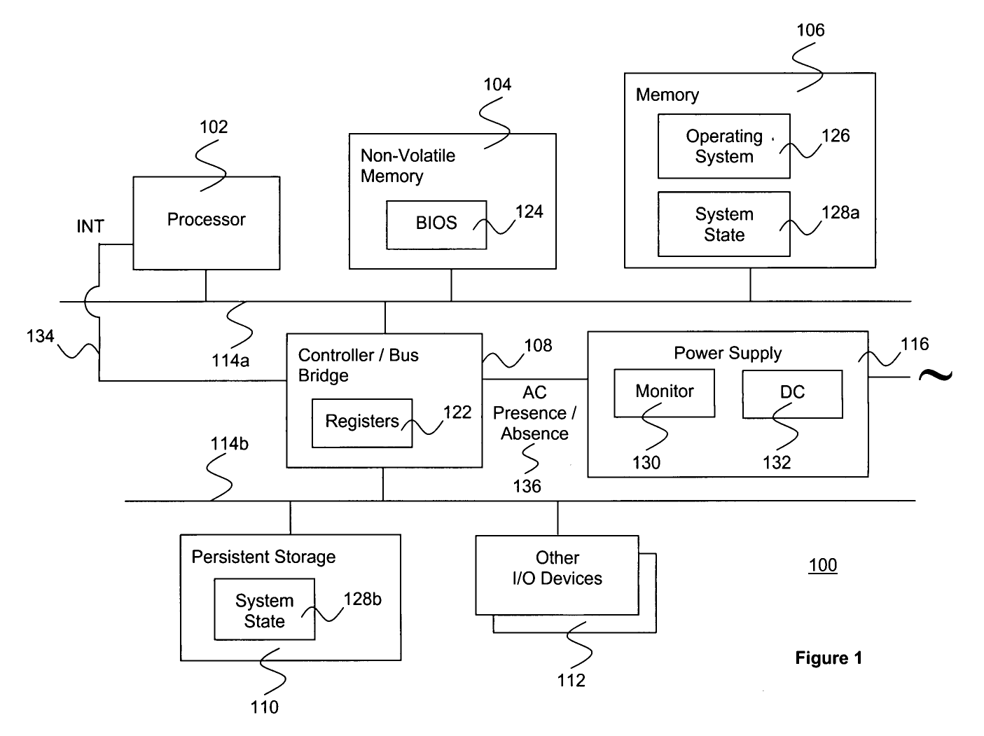

Referring now to FIG. 1 wherein an overview of a system incorporated with the teachings of one embodiment of the present invention is illustrated. For the embodiment, system 100 includes processor 102, non-volatile memory 104, memory 106, controller/bus bridge 108, persistent storage 110, other I/O devices 112, buses 114a-114b, and power supply 116, coupled to each other as shown. Controller/bus bridge 108 will also be referred to as memory and I/O controller/bus bridge, or MCH/ICH/BB.

Processor 102 includes in particular a terminal (e.g. a pin) to receive an interrupt 134. In particular, processor 102 is equipped to operate in at least a normal power consumption mode and a reduced power consumption mode. In various embodiments, processor 102 is equipped to be halted for a time period. During the time period, no instructions are executed, resulting in processor 102 consuming a reduced amount of power. However, processor 102 continues to maintain all relevant state information, e.g. the processor's program counter, stack pointer, internal cache, and so forth. The latency for processor 102 to return to its normal consumption mode of operation is insignificant for any operating system (OS) 126 to consider. In various embodiments, the reduced power consumption mode of operation complies with ACPI's C1 state, as defined by The ACPI Specification Revision 2.0b.

In other embodiments, processor 202 (in conjunction with MCH/ICH/BB 108) may also support additional ACPI reduced power consumption states, including but are not limited to the C2 and C3 states.

Non-volatile memory 104 includes in particular basic input/output system (BIOS) 124 equipped with the teachings an embodiment of the present invention, to be described more fully below. Memory 106 includes a working copy of operating system (OS) 126 and system state including applications and data 128a. OS 126 is equipped to initiate a suspend process to cause system 100 to go into a “suspended to memory” state.

MCH/ICH/BB 108 is equipped to interrupt processor 102, when system 100 is in an active state and an AC failed or absent condition arises. More specifically, for the embodiment, the interrupt is issued by the ICH portion of MCH/ICH/BB 108.

MCH/ICH/BB 108 further includes in particular a register 122 to facilitate OS 126 to cause system 100 to go into the “suspended to memory” state, and a register 122 to facilitate BIOS 124 to configure eligible wake events to wake up system 100.

Further, MCH/ICH/BB 108 is equipped to shut off delivery of “normal” power (leaving only standby power) to cause system 100 to go into a “suspended to memory” state. MCH/ICH/BB 108 is also equipped to process device wake events, including a notification of AC re-presence while system 100 is in a suspended to memory state. In particular, MCH/ICH/BB 108 is equipped to allow resumption of delivery of “normal” power, initiate waking of system 100, and facilitate BIOS to initiate a resume process. Similarly, for the embodiment, processing of device wake events is performed at the ICH portion MCH/ICH/BB 108. [AC=Alternating Current.]

In various embodiments, MCH/ICH/BB 108 may be further equipped with e.g. delay elements, to delay resumption of delivery of “normal power” and waking of system 100 when AC becomes re-available, after a period of absence. The additional ability may help to ensure that AC is stable before waking system 100 and triggering the resume process.

Power supply 116 includes integral backup DC power source 132, to source power for system 100 while system 100 is in an AC failed or absent condition, and a monitor 130 equipped to signal 136 presence or absence of AC power at power supply 116. An example of integral backup DC power source 132 is a battery. For the purpose of present application, the terms “AC failed”, “AC absent” and other variants should be considered synonymous, unless the context clearly indicates to the contrary. Hereinafter, integral backup DC power source 132 may also be simply referred to as either backup power source or DC power source. Further, in alternate embodiments backup power source may be a non-DC power source. [DC=Direct Current.]

Persistent storage 110 is employed to store, among other things, a persistent copy of system state including applications and data 128b when system 100 goes into the “suspended to memory” state. The term “system state” as used herein includes OS and application states and data.

Resultantly, system 100 may be advantageously maintained in a “suspended to memory” state (by the DC power source) for at least a critical period, even when AC power is lost, to allow a persistent copy of the system state to be saved. Further, system 100 may be smoothly brought back to the saved system state, when AC power returns.

Thus, system 100 may offer its user, usability experience that is similar to that of conventional consumer electronic devices, such as televisions. For example, from the user's perspective, a television “remembers” the last channel the television was tuned to, and is powered on tuning to the particular channel. By virtue of the teachings incorporated, embodiments of system 100 may likewise exhibit the same “remembering” behavior, turning on to its last state, after it has been “turned off”, from the user's perspective.

Still referring to FIG. 1, except for teachings of embodiments of the present invention incorporated, processor 102, non-volatile memory 104, memory 106, MCH/ICH/BB 108, persistent storage 110,1/0 devices 112, and buses 114a-114b all represent corresponding broad ranges of these elements. In particular, an example of an I/O device is a networking interface. Similarly, except for the teachings of an embodiment of the present invention incorporated, BIOS 124 and OS 126 also represent corresponding broad ranges of the elements.

Various embodiments of these teachings incorporated in BIOS 124, power supply 116, the operational states and various operational flows of system 100, as well as the manner these elements cooperate to provide the improvement will be described in turn below.

In various embodiments, system 100 may be a desktop computer, a set-top box, an entertainment control console, a video recorder, a video player or other processor based devices of the like.

Further, alternate embodiments may be practiced without some of the enumerated elements or with other elements. In particular, alternate embodiments may be practiced without DC power source 132 being an integral part of system 100. That is, for these embodiments, DC power is provided from a source external to system 100.

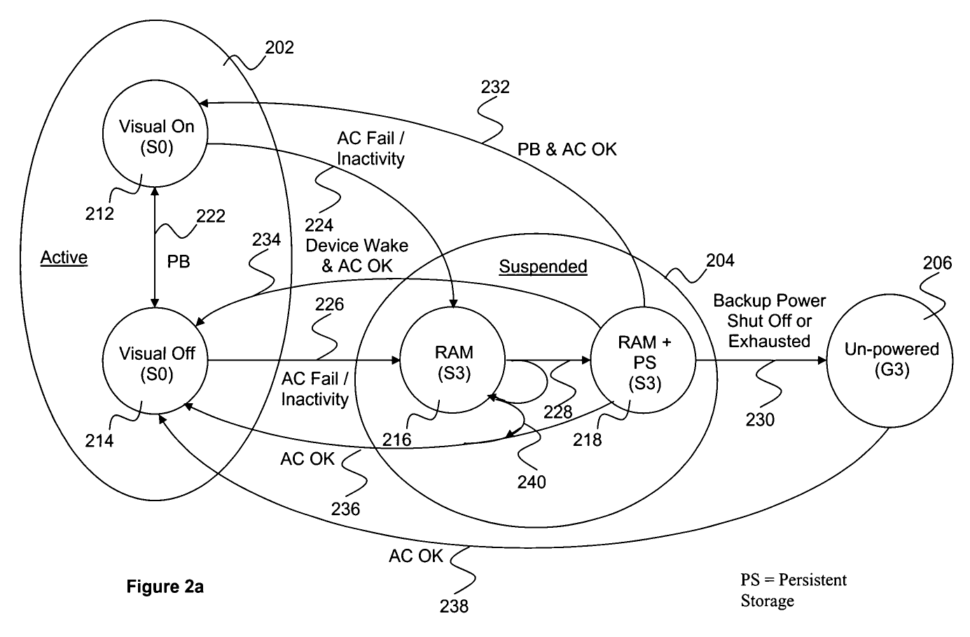

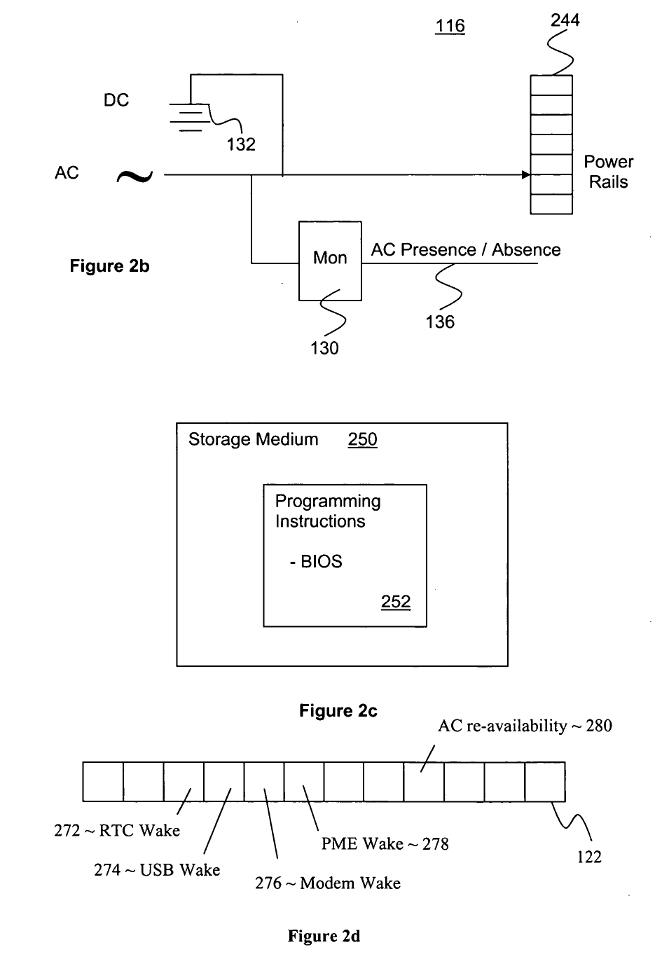

FIG. 2a illustrates one embodiment of the operational states of system 100. For ease of understanding, the operational states will be described assuming system 100 also includes implementation of ACPI, and mapped to the ACPI states. For the embodiment, the operational states of system 100 include three major operational states, active state (ACPI S0 or simply, S0) 202, suspended state (ACPI S3 or simply, S3) 204 and un-powered state (ACPI G3 or simply G3) 206. However, alternate embodiments may be practiced without mapping to ACPI states or implementation of ACPI. For further information these ACPI states, see also the earlier identified ACPI Specification, Revision 2.0b.

Within active state (S0) 202, system 100 may be in “visual on” state 212, or “visual off” state 214. While system 100 is in “visual on” state 212, user perceptible indications of system activity may be selectively activated as appropriate, including but are not limited to display devices, light emitting diodes (LEDs), speakers, and so forth. On the other end, while system 100 is in “visual off” state 214, all visual and aural elements of system 100 are “off”, giving a user the impression that system 100 has been “turned off”. As illustrated, system 100 may transition between “visual on” state 212 and “visual off” state 214 based at least in part on power button (PB) events 222.

Having visual “on” and “off” states 212 and 214 within active state (S0) 202 is a non-essential aspect of the disclosed embodiments of the present invention.

Still referring to FIG. 2a, for the embodiment, within suspended state (S3) 204, system 100 may be in “suspended to memory” state 216 or “suspended to memory with a persistent copy of the system state saved” state 218. System 100 may enter into “suspended to memory” state 216 from either “visual on” state 202 or “visual off” state 204, due to e.g. “inactivity”, user instruction, or an “AC failure” condition, 224 and 226. System 100 is considered to be in the “AC failure” condition, whenever AC is not present at power supply 116. Further, by virtue of the teachings provided, system 100 automatically saves a persistent copy of the then system state, and enters into “suspended to memory with a persistent copy of the system state saved” state 218.

For the embodiment, the system state saving process may be interrupted, e.g. by the resumption of AC power. As will be described in more detail below, the system state saving process is “aborted”, and the suspend process is allowed to proceed to completion (first portion of transition 240), resulting in system 100 entering suspended to memory state 216. At which time, system 100 immediately transitions back to visual off state 214, (remaining portion of transition 240).

From “suspended to memory with a persistent copy of the system state saved” state 218, system 100 may enter un-powered state (G3) 206 if the integral DC power source is shut off or exhausted 230. Shutting the DC power source off after a time period to prevent it from being exhausted is also not an essential aspect of the disclosed embodiments of the present invention. The feature is the subject matter of co-pending U.S. patent application, Ser. No. 10/644,683, entitled “Automatic Shut Off of DC Power Source in the Extended Absence of AC Power”, and filed on Aug. 19, 2003. For further details, see the co-pending application.

From “suspended to memory with a persistent copy of the system state saved” state 218, system 100 may transition back to either “visual on” state 212 or “visual off” state 214 in response to AC re-present in system 100 or a power button/device wake event 232/234 if AC is present (state 218 was entered due to inactivity). In various embodiments, the latter transitions are permitted only if AC is present at power supply 116 (state 218 was entered due to inactivity), else the power button or device wake events are suppressed.

Further, system 100 returns to “visual off” state 214 if AC becomes present again while system 100 is in “un-powered” state (G3) 206.

Referring now to FIG. 2b, wherein one embodiment of power supply 116 is illustrated. As shown, for the embodiment, power supply 116 includes integral backup DC power source 132 and monitor 130 as described earlier. Additionally, power supply 116 includes multiple power outputs (also referred to as power rails) 244. The elements are coupled to each other as shown.

Accordingly, power outputs 244 may continue to supply power to elements of system 100, drawing on integral DC power source 132, in the absence of AC at power supply 116. Further, monitor 130 is able to output a signal denoting whether AC is present or absent at power supply 116 at any point in time.

In various embodiments, DC power source 132 may be a battery. Monitor 130 may be implemented employing a diode and RC coupled to a comparator to provide signal 136. Further, a logical “1” of signal 136 denotes AC present at power supply 116, whereas a logical “0” of signal 136 denotes AC absent at power supply 116.

In various embodiments, in addition or in lieu of the “delay” ability provided to MCH/ICH/BB 108, power supply 116 may be further equipped with e.g. delay elements, to delay the outputting of signal 136 to denote availability of AC (re-presence), after it has been outputting signal 136 to denote the unavailability of AC (absence). The additional ability may help to ensure that AC is stable before signaling its re-presence.

In various embodiments, power outputs 244 may include normal and standby power outputs. Normal power outputs may include +12v, +5v, +3v, and −12v, whereas standby power output may include +5v. Further, normal power outputs or its delivery may be turned off.

Referring now FIG. 2d, an example register 122 suitable for use to facilitate configuration of eligible wake events for waking system 100, in accordance with one embodiment, is shown. As illustrated, register 122 includes a number of storage locations for storing a number of data bits to indicate (in accordance with the bit values) whether corresponding wake events are eligible or ineligible to wake system 100. For the embodiment, register 122 includes in particular bits 272-276 to indicate wake eligibility of wake events caused by a real time clock (RTC), universal serial bus (USB) activities, and modem activities respectively. Register 122 further includes bits 278-280 to indicate wake eligibility of wake events initiated by one of a number of peripheral control interface (PCI) devices (PME wake), and AC re-availability respectively. In alternate embodiments, more or less configurable wake events may be supported.

FIG. 2c illustrates an example article having programming instructions implementing all or the relevant portions of BIOS 124 of FIG. 1, in accordance with one embodiment. As illustrated, article 250 includes a storage medium 252 and programming instructions 252 implementing all or the relevant portions of BIOS 124 of FIG. 1. As alluded to earlier and to be described in more detail below, BIOS 124 includes teachings of one embodiment of the present invention to facilitate preservation of operational state of system 100 when it is in an “AC failed” condition.

For the embodiment, article 250 may be a diskette. In alternate embodiments, article 250 may be a compact disk (CD), a digital versatile disk (DVD), a tape, a compact Flash, or other removable storage device of the like, as well as a mass storage device, such as a hard disk drive, accessible for downloading all or the relevant portions of BIOS 124 via e.g. a networking connection.

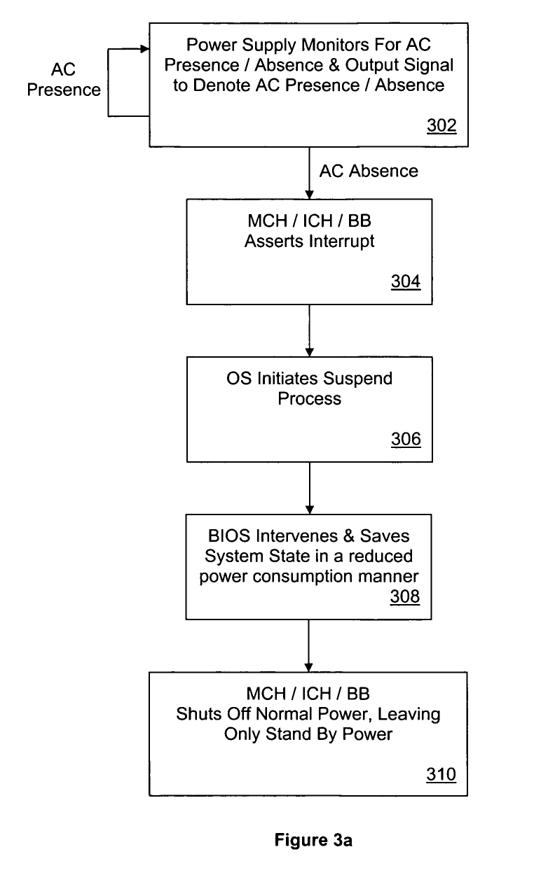

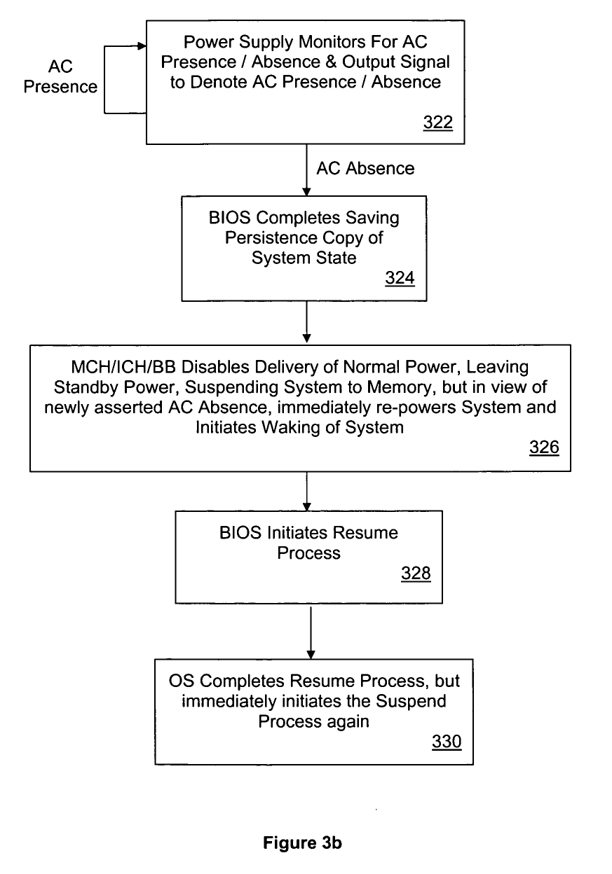

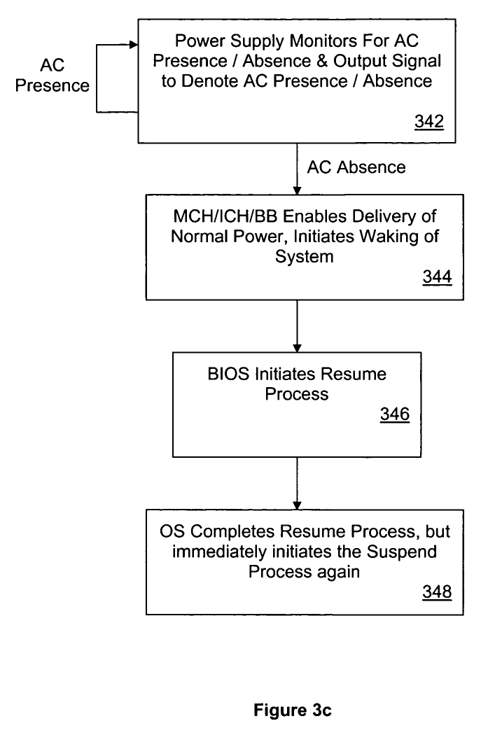

FIG. 3a illustrates one embodiment of the relevant operation flow of system 100 to suspend system 100 in memory in responding to an AC failure condition, while operating in active state 202.

As illustrated, while operating in active state 202, power supply 116 monitors for AC presence or absence, and outputs a signal to denote AC presence or absence accordingly, block 302. In alternate embodiments, the monitoring and signaling of AC presence or absence at power supply 116 may be performed by another element other than power supply 116. Regardless, the monitoring and signaling continues as long as AC is present at power supply 116.

However, when AC fails or absents from power supply 116, and monitor 130 outputs a signal so denoting, for the embodiment, MCH/ICH/BB 108 asserts an interrupt, notifying processor 102 of the AC failure or absence condition, block 304. For the purpose of this application, the terms “AC failure” and “AC absent” are synonymous. In various embodiments, as described earlier, the interrupt is asserted by the ICH portion of MCH/ICH/BB 108.

For the embodiment, in response to the interrupt, processor 102 switches execution to a portion of OS 126 (interrupt handler), which responds by initiating a suspend to memory process, block 306. More specifically, OS 126 attempts to write to register 122 of MCH/ICH/BB 108 to cause MCH/ICH/BB 108 to shut off delivery of the normal power outputs of power supply 116, and make available only the standby power output for a small number of elements, such as memory 106.

For the embodiment, system 100 is equipped, and initialized to generate an interrupt to transfer control to a designated interrupt handler of BIOS 124 in response to the OS write. In various implementations, the interrupt may be the unmaskable System Management Interrupt (SMI).

Accordingly, for the embodiment, BIOS 124 is able to intervene in the suspend to memory process, and save a persistent copy of the then system state in a persistent storage device, such as a hard disk drive, block 308. Upon saving the persistent copy of the then system state in a persistent storage device, BIOS 124 completes the OS write to register 122 of MCH/ICH/BB 108, block 308.

In various embodiments, BIOS 124 initiates a number of data transfer operations to transfer at least selected contents from memory 106 to persistent storage 110 to effectuate creating persistent copy of system state 128b. More specifically, BIOS 124 initiates a number of direct memory accesses (DMA) of memory 106 to effectuate the autonomous transfer of the contents of memory to persistent storage 110. In various embodiments, the DMA are performed by a DMA engine (not shown).

Additionally, to further preserve the backup power, upon initiating the data transfer operations, BIOS 124 sets up a timer to expire after a time period to interrupt processor 102 to cause processor 102 to return to a normal power consumption mode of operation. Upon setting up the timer, BIOS 124 causes the processor 102 to enter a reduced power consumption mode of operation. More specifically, in an embodiment where processor 102 implements ACPI power states C0 and C1, BIOS 124 halts processor 102 causing processor 102 to transition from operating in power state C0 (normal power consumption) to power state C1 (reduced power consumption).

In other embodiments where processor 102 also implements ACPI power states C2 or C2 and C3, BIOS 124 may cause processor 102 to transition to power state C2 or C3.

On expiration of the timer and processor 102 is interrupted, BIOS 124 is given control again. At such time, BIOS 124 checks to determine if the data transfer operations have completed. In various embodiments, BIOS 124 checks for a completion bit in one of the control blocks allocated in memory 104 for conducting the DMA.

The time it takes to complete the copy operation is dependent on the amount of memory 106 (e.g. the allocated memory) to be copied, and the speed data may be transferred to persistent storage 110. In various embodiments, the time period BIOS 124 places processor 102 in the reduced power consumption state is based on an estimate of the time it takes to complete the copy operation (allowing for some margin of variance, biasing on the conservative side, to effectuate placing system 100 in the suspended to memory state as soon as possible). BIOS 124 may be pre-configured with a default estimate or it may compute the estimate dynamically.

Thus, when BIOS 124 first checks for the completion of the data transfer operations when processor 102 returns to the normal power consumption mode of operation, typically, the data transfer operations are not fully completed yet. For the embodiment, BIOS 124 simply repeatedly checks for the completion of the data transfer operations, with decreasing amount of wait time in between checks.

However, in alternate embodiments, especially in embodiment where the time period BIOS 124 causes processor 102 to operate in the reduced power consumption mode of operation is a conservatively selected short time period, BIOS 124 may repeat again the power saving process, i.e. setting up the timer and causing processor 102 to enter a reduced power consumption mode of operation. The power saving process may be repeated with increasingly more conservative shorter time period.

Alternatively, the DMA engine may be equipped to interrupt the processor (in lieu of the timer) to facilitate the earlier described transfer back of control to the BIOS.

In any case, in due course, BIOS 124 determines that the data transfer operations are completed, i.e. persistent copy of system state 128b has been created. At such time, in various embodiments, BIOS 124 marks persistent copy of system state 128b as a valid saved copy. In various embodiments, BIOS 124 marks the validity by setting a flag. In one embodiment, the flag is also stored in persistent storage 110.

Further, in various embodiments, upon initially given control, BIOS 124 determines if the suspend process is initiated in response to an AC failure condition, i.e. whether system 100 is in an AC failure condition, as the suspend process may also be initiated by a user, an application or OS 126 for other reasons. Upon determining that the suspend process is initiated in response to an AC failure condition, BIOS 124 further configures register 122 to indicate all wake events, except AC re-availability, as ineligible to wake system 100, to increase the likelihood of the sufficiency of the backup power to maintain system 100 in the suspended to memory state, until AC becomes available again.

In one embodiment where automatic shut off of backup power source 132 after a period of time is supported, in block 308, BIOS 124 also sets up an arrangement to subsequently shut off backup power source 132 after elapse of the time period, before completing the OS write to register 122 of MCH/ICH/BB 108. One arrangement may involve the employment of the system's real time clock (RTC) to wake system 100 to provide BIOS 124 the opportunity to shut off backup power. For the arrangement, instead of limiting AC re-availability as the only eligible wake event to wake system 100, BIOS 124 further includes RTC as an eligible wake event to wake system 100 (e.g. by not rendering it ineligible).

As described earlier, the action of writing to register 122 causes delivery of the normal power outputs of power supply 116 to be shut off by MCH/ICH/BB 108, and leaving only delivery of the standby power output for a small number of elements, such as memory 106, block 310.

Thus, in response to the OS initiation to place system 100 in the “suspended to memory” state 216, system 100 is advantageously placed in the “suspended to memory with a persistent copy of the system state saved” state 218 instead. System 100 may later be smoothly brought back to an active state when AC power returns.

Still referring to FIG. 3a, additionally, as described earlier, BIOS 124 may be interrupted while saving a persistent copy of the system state, e.g. by the resumption of AC power. At such time, for the embodiment, BIOS 124 “aborts” the saving operation, and proceeds immediately to complete the suspend process, block 308, resulting in system 100 entering suspended to memory state 216 (first portion of transition 240).

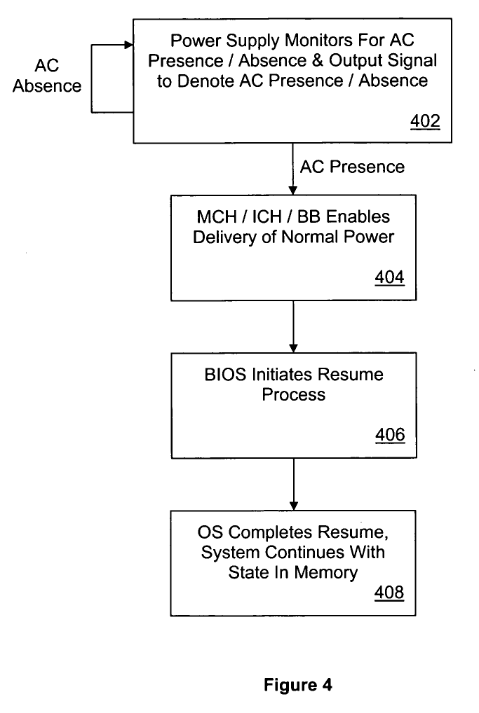

At which time, system 100 immediately transitions back to visual off state 214 (remaining portion of transition 240). This process is similar to the process to be described later referencing FIG. 4, for transitioning from suspended state 218 to visual off state 214.

In various embodiments, BIOS 124 detects the resumption of AC power while the data transfer operations are being performed, by continuously polling the source(s) of the eligible wake event(s). In embodiments where AC re-availability is the only eligible wake event (if the suspend process is initiated in response to AC failure), only the source (e.g. power supply) that provides the AC presence or absence condition is polled.

For the embodiments where causing processor 102 to operate in a reduced power consumption mode while the data transfer operations are being performed is also supported, BIOS 124 may perform the polling, substantially concurrent with it checking for completion of the data transfer operations (when processor 102 returns to a normal power consumption mode of operation).

Referring now to FIGS. 3b and 3c, additionally, AC failure or absence may also occur while BIOS 124 is saving the persistent copy of the system state, or after BIOS 124 has completed the saving process, and system 100 is in “suspended” state 218. The saving process is part of a suspend process initiated due to a reason other than AC failure, e.g. inactivity. FIG. 3a-3b illustrate one embodiment each of the relevant operation flow of system 100 in responding to an AC failure condition arisen under each of the foregoing described situations respectively.

As illustrated in FIG. 3b, for the former case (i.e. AC failure while BIOS 124 is saving a persistent copy of the system state as part of a suspend process initiated due to a reason other than AC failure), notwithstanding the signaling of the AC failure condition, block 322, BIOS 124 proceeds to complete the saving of the persistent copy of the system state, and thereafter, continues the suspend process, block 324. Note that at this point in time, system 100 is powered by backup power source 132. Further, in various embodiments, if the suspend process is initiated for a reason other than AC failure, BIOS 124 may skip the earlier described power conservation practice while creating the persistent copy of system state 128a. However, BIOS 124 may start the power conservation practice on detection of AC failure while the persistent copy of the system state 128 is being created. That is, BIOS 124 would cause processor 102 to transition to a reduced power consumption of mode of operation for a time period, and return to a normal power consumption of mode of operation for BIOS 124 to check for the completion of the data transfer operations, and/or AC re-availability, as described earlier.

Still referring to FIG. 3b, next, MCH/ICH/BB 108 shuts off delivery of normal power, leaving only standby power, thereby placing system 100 in suspended state 218, as described earlier, block 326. However, MCH/ICH/BB 108 immediately re-enables delivery of normal power, and initiates waking of system 100, block 326.

In response, BIOS 124 initiates hardware elements and a resume process, using e.g. a resume vector previously set up by OS 126, block 328.

At block 330, OS 126 completes the resume process. However, OS immediately re-initiates another suspend process, in view of the AC failure condition, leading to the process earlier described referencing FIG. 3a being performed.

FIG. 3c illustrates one embodiment of the relevant operation flow of system 100 (equipped with the shut off feature) in responding to an AC failure condition arisen while system 100 is in suspended state 218.

As illustrated in FIG. 3c, for the latter case (i.e. AC failure after BIOS 124 has completed saving a persistent copy of the system state as part of a suspend process initiated due to a reason other than AC failure), when AC absence is signaled, block 342, MCH/ICH/BB 108 resumes delivery of normal power, and initiates a system wake process, block 344.

In response, similar to the process of FIG. 3b, BIOS 124 initiates hardware elements and a resume process, block 346. Thereafter, at block 348, OS completes the resume process as described earlier. However, OS immediately re-initiates another suspend process, in view of the AC failure condition, leading to the process earlier described referencing FIG. 3a being performed.

Each of the foregoing embodiments of FIGS. 3b and 3c (for responding to AC absence when BIOS 124 is saving or has completed saving a persistent copy of the system state as part of a suspend process initiated due to e.g. inactivity) has been described employing an approach that resumes to OS 126 to re-initiate another suspend process. However, alternate embodiment may be practiced without resuming to OS 126. For example, BIOS 124 may be further equipped to maintain sufficient information to recognize that system 100 is being awaken because AC failed when BIOS 124 was saving or had completed saving a persistent copy of the system state as part of a suspend process initiated due to e.g. inactivity. Moreover, BIOS 124 is further equipped to proceed to perform the operations it normally performs (as earlier described referencing FIG. 3a) during a suspend process initiated due to AC failure, upon so recognizing the cause for system 100 being awaken.

FIG. 4 illustrates the relevant operation flow of system 100 to resume system 100 into an active state, in responding to an AC re-presence condition, while operating from the DC power source in suspended state 218. Recall from earlier description, for the embodiment, suspended state 218 is the “suspended to memory with a persistent copy of the system state saved” state.

As illustrated, for the embodiment, while operating from the DC power source 132 in “suspended to memory with a persistent copy of the system state saved” state 218, power supply 116 monitors for AC presence or absence, and outputs a signal to denote AC presence or absence accordingly, block 402. Again, as described earlier, in alternate embodiments, the monitoring and signaling of AC presence or absence at power supply 116 may be performed by another element other than power supply 116. Regardless, the monitoring and signaling continues as long as AC is absent at power supply 116.

However, when AC is re-present at power supply 116, and monitor 130 outputs signal 136 so denoting. For the embodiment, MCH/ICH/BB 108 responds to signal 136 as a device wake event, re-enabling delivery of normal power outputs of power supply 116 to elements of system 100, and then transfers control to BIOS 124, block 404. As described earlier, in various embodiments, the device wake event is processed by the ICH portion of MCH/ICH/BB 108.

At block 406, BIOS 124 performs various initializations of hardware elements as appropriate, and transfers control to a resume vector previously set up by OS 126 (as part of the suspend to memory process). For embodiments with the backup power shut off feature, BIOS 124 may also additionally cancel any scheduled shut off.

At block 408, OS 126 completes the resume process, and system 100 continues operation, starting from the previously suspended system state in memory 106.

In various embodiments, in addition or in lieu of the “delay” ability provided to MCH/ICH/BB 108 and/or power supply 116, BIOS 124 may be further equipped to delay performing the above described “resume” related operations, in response to an “AC re-presence” wake event (e.g. by waiting for a short time period before responding). Similarly, the additional ability may help to ensure that AC is stable before resuming system 100.

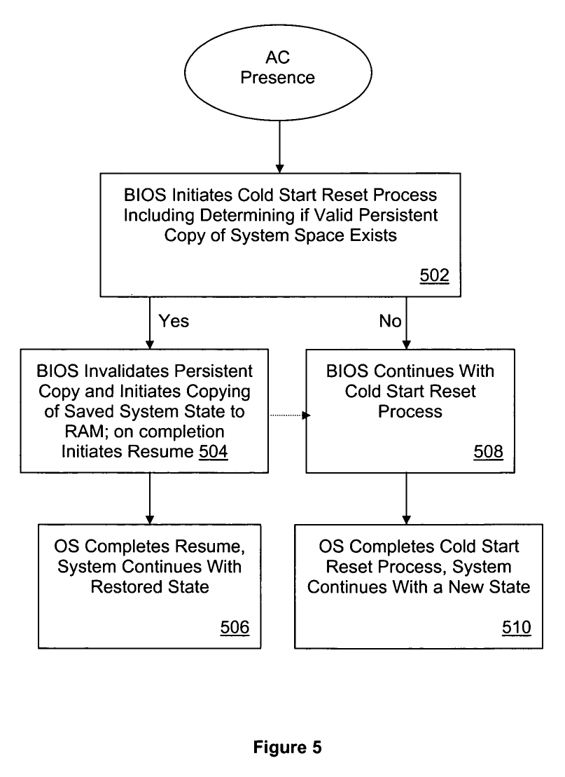

FIG. 5 illustrates the relevant operation flow of system 100 in responding to an AC re-presence condition, while operating in un-powered state (G3) 206. For the embodiment, when AC is re-present at power supply 116, the event causes a cold start reset for system 100. Accordingly, BIOS 124 is given control, and it starts the cold start process to initialize various hardware elements. As part of the cold start process, BIOS 124 determines whether a valid persistent copy of the system state exists, block 502.

If a valid persistent copy of the system state exists, BIOS 124 initiates a number of data transfer operations to copy the persistent copy of the system state into memory 106, block 504. Additionally, either before or substantially concurrent with the initiation with the data transfer operations, BIOS 124 marks the persistent copy of the system state found as invalid. Note that while the marking operation effectively allows only one attempted restoration for each persistent copy of system state, the marking operation advantageously ensures the integrity of system 100.

In alternate embodiments, BIOS 124 may be further equipped with the ability to check on whether the OS re-starts successfully. BIOS 124 may e.g. employ a watchdog timer, to accord itself the opportunity to perform such check. For these embodiments, BIOS 124 may mark the persistent copy of the system state invalid after the OS re-started successfully, or after n failed attempts, where n may be configurable.

Continue to refer to FIG. 5, upon successful copying of the persistent copy of system state into memory 106, BIOS 124 continues with operations similar to the operations performed under a resume process, resulting in OS 126 completing the resume process, and system 100 continues operation, starting from the restored system state in memory 106, block 506.

In embodiments where BIOS 124 disables eligibility of all wake events, except AC re-availability, BIOS 124 may re-enable the disabled wake events' eligibility, prior to resuming to OS 126. Alternatively, re-enablement of the wake events' eligibility may be re-established by the device drivers of the various devices in response to a resume notification provided by OS 126 as part of the resume process.

However, if a persistent copy of the system state is not found or for some reasons, restoration of the persistent copy of the saved system state is unsuccessful, BIOS 124 continues with the cold start process, performing various initializations of hardware elements, and then transfers to OS 126, block 508. At such time, OS 126 completes the cold start process, and system 100 continues operation, starting from a new system state in memory 106, block 510.

Thus, it can be seen from the above description, a method to preserve operational state in the absence of AC has been described. In particular, embodiments of system 100 may be maintained in a suspended-to-memory state from a DC power source, for at least a period, during AC absence, sufficient to allow the persistent copy of the system state to be made. As a result, embodiments of system 100 may be returned to the system state saved when AC is returned.

As described earlier, the feature is particularly useful in offering the user of a computing device, usability experience that is more similar to conventional consumer electronic devices, such as a television.

Technology which allows a computing device such as a personal computer (PC) is described above helps to allow the device to act more like a television in terms of turning it on/off (and/or appearing to turn on/off) while keeping its settings persistent (for example, channel, volume, etc.). A key feature of the success of this technology is power resiliency, for example, where a device that is similar to a small UPS (Uninterruptible Power Source) allows the system to shut down and save memory contents to a non-volatile storage device (for example, a hard disk drive).

While today's Operating Systems (OSes) have hibernate capability and a suspended state (for example, ACPI S3, or simply S3), they do not include a protected suspended state (for example, a protected S3 state or “suspended to memory with a persistent copy of the system state saved” state). If power loss occurs during a suspended state (such as S3 ACPI suspend to RAM), the system must resume to a working state and then begin the long and arduous task of saving memory to disk. This arduous task typically requires a large UPS battery.

In order to reduce battery size in this environment a protected suspended state has been described above (for example, a “suspended to memory with a persistent copy of the system state saved” such as state 218 described above). In this type of protected suspended state the contents of memory are stored to a non-volatile storage device (for example, to a disk) each time the suspended state (for example, S3) is entered. This stored recovery memory image is only needed if the power is removed while in the suspended state. However, since prior and/or current OSes do not support a protected suspended state, the basic input/output system (BIOS) must perform this action after the OS has released control to the platform. However, the time that it takes to save the memory contents to the non-volatile storage device (for example, disk) is a big factor in determining how big of a battery is necessary to enable such an operation. Therefore, according to some embodiments, the time required for performing such a backup operation is reduced.

According to some embodiments a BIOS-based hibernate operation reduces the amount of system memory that is required to be saved to non-volatile storage such as a hard disk drive. This reduction helps to increase the speed of the hibernate operation and thus reduces the power required for such an operation.

According to some embodiments, a UPS and/or battery is used to hold a computing device such as a PC in a working state after an AC power loss long enough to place the system into a special protected reduced power state (for example, protected S3 state or S3p state) in which the system memory is stored to a non-volatile storage device (for example, a hard disk drive). Since the operation is performed while on UPS and/or battery power, it is imperative that the operation complete as quickly as possible.

The BIOS typically has no insight into what memory and/or memory locations are in use by the OS and into what other software is loaded at the moment the hibernate operation is initiated. Therefore, the BIOS usually must save the complete memory image to non-volatile memory and/or a non-volatile storage device to assure that all necessary data has been saved. This is true even if only a small amount of the entire system memory is actually in use at the time.

According to some embodiments, the BIOS is allowed to have explicit knowledge of “unused” portions of memory. Armed with this information, the BIOS does not have to save the unused memory contents to disk, thus saving time and power

According to some embodiments, a helper driver is loaded in the OS. When the suspended state operation (for example, S3 operation) begins, the driver allocates large amounts of non-paged memory. Once allocated by the driver, this non-paged memory is not used by any other software in the system and can be disregarded when saving the memory image to persistent storage (for example, a non-volatile storage device such as a hard disk drive). The memory does not have to be contiguous as long as the driver can faithfully represent the physical pages allocated. This representation of the unused physical memory pages can be passed to the BIOS, which in turn can skip saving these physical memory pages to non-volatile storage such as disk. The map of physical memory pages can be placed in the allocated memory. A physical address pointer to this map is relayed to the BIOS (for example, by way of a fixed portion of the non-volatile storage, an ACPI table, and/or some other mechanism).

According to some embodiments, once the BIOS gains control, for example, by way of an SMI (System Management Interrupt) after the OS writes the suspended state sleep enable (for example, S3 sleep enable), it can find the pointer to the page map and start saving the “used” memory contents to non-volatile storage. The BIOS can also save the page map to non-volatile storage. During a restore operation the BIOS can read back the page map and reload memory from the non-volatile storage back into the proper memory pages. After the system is restored, the driver then releases all the memory that it allocated, thus returning the system to a normal working state.

According to some embodiments, in order to overcome the lack of information that the BIOS has about used and/or unused system memory, one or more of the following features are provided:

A driver at the operating system (OS) level, which, when the suspended state (for example, S3) is initiated, the driver allocates large amounts of non-paged memory and creates a physical memory map of the allocated memory. After the system is restored, the allocated memory can then be freed.

A method of relaying the physical memory map to the BIOS.

A BIOS which intercepts the suspended state operation (for example, S3 operation) (for example, via an SMI trap), then reads the memory map created by the driver and saves the memory map and system memory, disregarding the portions allocated by the driver. During restore, the BIOS reads back the memory map and reads the memory back to memory, not needing to restore the driver allocated portions of memory.

According to some embodiments the BIOS is allowed to have insight into unused portions of system memory without requiring those memory regions to be saved during a storing of memory to persistent storage. This saves time and power, which are both critical when running on battery power.

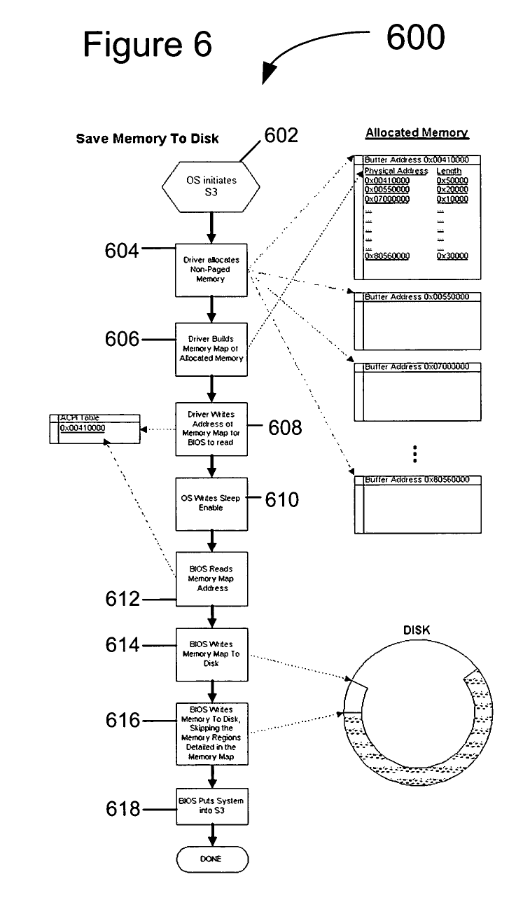

FIG. 6 illustrates a flowchart 600 describing saving memory to non-volatile storage according to some embodiments. According to some embodiments flowchart 600 illustrates a save to non-volatile storage (for example, disk) during a suspended state operation (for example, an S3 operation or a protected S3 operation and/or an S3p operation).

At 602 an Operating System (OS) or other software initiates a suspended state operation (for example, a suspend operation and/or an S3 operation) to place the system into a low power mode. The OS sends messages to the drivers to indicate the suspend action. When the driver gets the message it then allocates a large amount of non-paged memory at box 604 (for example, see the dotted arrows extending from box 604 to allocated memory locations in FIG. 6). The driver can limit the amount of allocated memory to avoid excessive swapping of pages by the OS during the remainder of the suspend operation. The allocated memory pages do not have to be contiguous, but large blocks are preferable according to some embodiments.

Once the blocks have been allocated, the driver builds a memory map at 606 (for example, see the dotted arrow extending from 606 to allocated memory locations in FIG. 6). According to some embodiments, the driver uses one of the allocated memory blocks as a buffer to place a table mapping these allocated memory regions to physical addresses and lengths. According to some embodiments, the driver provides a complete memory page bitmap indicating pages to be saved and/or not saved.

At 608 the driver loads the physical address of the table in a location that can be read by the BIOS. For example, according to some embodiments as illustrated by the dotted arrow extending from 608 to an ACPI table in FIG. 6, the driver uses a common ACPI table to communicate the address of the memory map table. The OS writes a sleep enable at 610. When the BIOS gets control, the BIOS reads the memory map address (for example, the address of the ACPI table) at 612 and examines the contents. By decoding which memory pages are allocated by the driver, the BIOS can confidently refrain from writing them to non-volatile storage (for example, a disk). Before writing the memory contents to non-volatile storage, the BIOS writes the memory page map table to non-volatile storage (for example, a disk) at 614 as illustrated, for example, by the dotted arrow extending from 614 to a disk in FIG. 6. This allows the BIOS to determine which memory pages reside on the non-volatile storage and where in memory they belong. The BIOS writes memory contents to non-volatile storage at 616 (as illustrated, for example, by the dotted line extending from 616 to the disk in FIG. 6). In writing memory contents to non-volatile storage at 616, the BIOS skips the unused memory regions detailed in the memory map. Then the BIOS puts the system into a suspended state (for example, S3) at 618. In this manner, when the system wants to enter a suspended state (for example, S3), memory contents are first backed up on non-volatile storage in a manner that minimizes the time and power necessary for the backup operation.

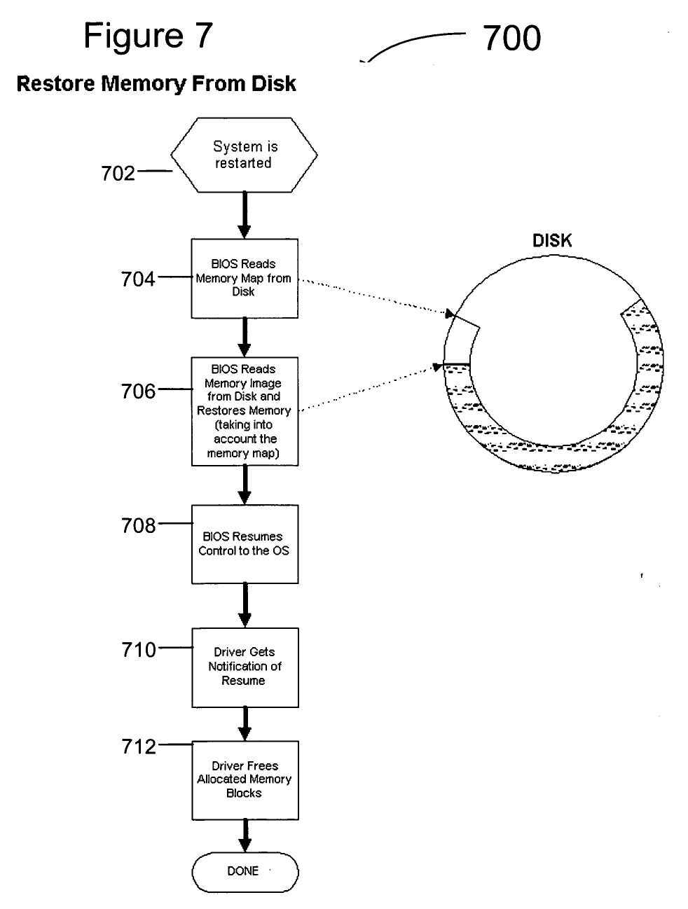

FIG. 7 illustrates a flowchart 700 describing restoring memory contents from a non-volatile storage according to some embodiments. According to some embodiments, flowchart 700 illustrates a restore operation occurring after a save operation has been performed which is the same as and/or is similar to the operation illustrated in flowchart 600 illustrated in FIG. 6.

The system is restarted at 702 (for example, by a wake event, a user pressing a button, etc.) The BIOS reads the memory map from non-volatile storage at 704 in order to restore memory from the non-volatile storage (for example, as illustrated by the dotted arrow extending from 704 to a disk in FIG. 7). Using the memory map read from non-volatile storage, at 706 the BIOS can then determine which memory pages reside on the non-volatile storage and where they should be placed in system memory. Once the memory is restored, the BIOS passes control back to the OS, which effectively completes the platform portion of the suspend state (for example, S3) resume. After the OS gains control at 708, it sends a message to the driver which indicates the completion of the resume. The driver receives this notification at 710. At this point, the driver frees the memory it allocated during the suspend cycle at 712, and all utilized memory is returned to the state it was in before the suspend operation was initiated.

According to some embodiments, the amount of system memory that the BIOS needs to save to persistent storage (non-volatile storage) during its protected suspend state operation is minimized. The power necessary to perform the store operation and/or a restore operation is decreased and therefore the necessary battery capacity required for performing such a store operation and/or restore operation is significantly reduced.

According to some embodiments a combination of driver software and BIOS are used to perform an intelligent save to non-volatile storage (for example, disk) and/or an intelligent restore from non-volatile storage without direct knowledge of the OS internals. This allows for more efficient use of system resources while performing a BIOS supported save memory to non-volatile storage and/or restore memory from non-volatile storage operation.

While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
in response to initiation of a suspended state operation of a system, allocating non-paged memory using a driver;
building a memory map of allocated memory using the driver;
writing an address of the memory map using the driver;
reading the memory map using a BIOS;
writing the read memory map to a non-volatile storage using the BIOS;
writing memory contents to the non-volatile storage, skipping non-used memory regions in response to the memory map using the BIOS; and
putting the system into a suspended state after writing the contents of memory to the non-volatile storage.

2. The method of claim 1, wherein the writing of the address of the memory map is performed using an ACPI table.

3. The method of claim 1, wherein the writing of the address of the memory map is performed using a fixed portion of the non-volatile storage.

4. The method of claim 1, wherein the memory map is read using the BIOS in response to a sleep enable written by an Operating System.

5. The method of claim 1, wherein the non-volatile storage includes at least one hard disk drive.

6. The method of claim 1, wherein the suspended state is an ACPI S3 state.

7. The method of claim 1, wherein one memory block of the allocated memory is used as a buffer to place a table mapping allocated memory regions to physical addresses and lengths.

8. The method of claim 1, wherein the allocated memory is used to provide a complete memory page bitmap indicating pages to be saved and pages not to be saved.

9. The method of claim 1, wherein the allocated memory is used to provide a complete memory page bitmap indicating pages to be saved or pages not to be saved.

10. The method of claim 1, further comprising:
restarting the system after the system was put into the suspended state;
reading the memory map from the non-volatile storage;
determining which memory pages reside on the non-volatile storage and determining locations where they should be placed in memory; and
writing the determined memory pages to memory in the determined locations.

11. The method of claim 10, wherein the restarting of the system is performed in response to a wake event.

12. The method of claim 10, wherein the restarting of the system is performed in response to a user pressing a button.

13. The method of claim 10, further comprising freeing allocated memory blocks.

14. The method of claim 1, further comprising:
restarting the system after the system was put into the suspended state;
reading the memory map from the non-volatile storage using the BIOS;
determining which memory pages reside on the non-volatile storage and determining locations where they should be placed in memory using the BIOS;
writing the determined memory pages to memory in the determined locations using the BIOS;
resuming control from the BIOS to an Operating System;
notifying the driver of the resuming of control; and
freeing allocated memory blocks using the driver.

15. An article comprising:
a computer readable medium having instructions thereon which when executed cause a computer to:
allocate non-paged memory in response to initiation of a suspended state operation of a system using a driver;
build a memory map of allocated memory using the driver;
write an address of the memory map using the driver;
read the memory map using a BIOS;
write the read memory map to a non-volatile storage using the BIOS;
write memory contents to the non-volatile storage, skipping non-used memory regions in response to the memory map using the BIOS; and
put the system into a suspended state after writing the contents of memory to the non-volatile storage.

16. The article of claim 15, wherein the write of the address of the memory map is performed using an ACPI table.

17. The article of claim 15, wherein the write of the address of the memory map is performed using a fixed portion of the non-volatile storage.

18. The article of claim 15, wherein the memory map is read using the BIOS in response to a sleep enable written by an Operating System.

19. The article of claim 15, wherein the suspended state is an ACPI S3 state.

20. The article of claim 15, the computer readable medium having instructions thereon which when executed further cause a computer to:
restart the system after the system was put into the suspended state;
read the memory map from the non-volatile storage;
determine which memory pages reside on the non-volatile storage and determining locations where they should be placed in memory; and
write the determined memory pages to memory in the determined locations.

21. The article of claim 15, the computer readable medium having instructions thereon which when executed further cause a computer to:
restart the system after the system was put into the suspended state;
read the memory map from the non-volatile storage using the BIOS;
determine which memory pages reside on the non-volatile storage and determining locations where they should be placed in memory using the BIOS;
write the determined memory pages to memory in the determined locations using the BIOS;
resume control from the BIOS to an Operating System;
notify the driver of the resuming of control; and
free allocated memory blocks using the driver.

22. An apparatus comprising:
a driver to allocate non-paged memory in response to initiation of a suspended state operation of a system, to build a memory map of allocated memory, and to write an address of the memory map; and
a BIOS to read the memory map, to write the read memory map to a non-volatile storage, to write memory contents to the non-volatile storage in a manner that skips non-used memory regions in response to the memory map, and to put the system into a suspended state after writing the contents of memory to the non-volatile storage.

23. The apparatus of claim 22, further comprising an ACPI table in which to write the address of the memory map.

24. The apparatus of claim 22, wherein the driver is to write the address of the memory map in a fixed portion of the non-volatile storage.

25. The apparatus of claim 22, wherein the BIOS is to read the memory map in response to a sleep enable written by an Operating System.

26. The apparatus of claim 22, wherein the suspended state is an ACPI S3 state.

27. The apparatus of claim 22, wherein one memory block of the allocated memory is used as a buffer to place a table mapping allocated memory regions to physical addresses and lengths.

28. The apparatus of claim 22, wherein the allocated memory is used to provide a complete memory page bitmap indicating pages to be saved and pages not to be saved.

29. The apparatus of claim 22, the BIOS further to read the memory map from the non-volatile storage to determine which memory pages reside on the non-volatile storage, to determine locations where the determined memory pages should be placed in memory, and to write the determined memory pages to memory in the determined locations.

30. The apparatus of claim 29, the driver further to free allocated memory blocks.

31. The apparatus of claim 22, the BIOS further to read the memory map from the non-volatile storage, to determine which memory pages reside on the non-volatile storage and to determine locations where they should be placed in memory, and to write the determined memory pages to memory in the determined locations, and to resume control to an Operating System, the driver further to receive notification of a resume and to free allocated memory blocks.

32. A system comprising:
a memory;
a non-volatile storage;
a driver to allocate non-paged memory in response to initiation of a suspended state operation of the system, to build a memory map of allocated memory, and to write an address of the memory map; and
a BIOS to read the memory map, to write the read memory map to the non-volatile storage, to write contents of the memory to the non-volatile storage in a manner that skips non-used memory regions in response to the memory map, and to put the system into a suspended state after writing the contents of memory to the non-volatile storage.

33. The system of claim 32, further comprising an ACPI table in which to write the address of the memory map.

34. The system of claim 32, wherein the driver is to write the address of the memory map in a fixed portion of the non-volatile storage.

35. The system of claim 32, wherein the BIOS is to read the memory map in response to a sleep enable written by an Operating System.

36. The system of claim 32, wherein the non-volatile storage includes at least one hard disk drive.

37. The system of claim 32, wherein the suspended state is an ACPI S3 state.

38. The system of claim 32, wherein one memory block of the allocated memory is used as a buffer to place a table mapping allocated memory regions to physical addresses and lengths.

39. The system of claim 32, wherein the allocated memory is used to provide a complete memory page bitmap indicating at least one of pages to be saved and pages not to be saved.

40. The system of claim 32, the BIOS further to read the memory map from the non-volatile storage to determine which memory pages reside on the non-volatile storage, to determine locations where the determined memory pages should be placed in memory, and to write the determined memory pages to memory in the determined locations.

41. The system of claim 40, the driver further to free allocated memory blocks.

42. The system of claim 32, the BIOS further to read the memory map from the non-volatile storage, to determine which memory pages reside on the non-volatile storage and to determine locations where they should be placed in memory, and to write the determined memory pages to memory in the determined locations, and to resume control to an Operating System, the driver further to receive notification of a resume and to free allocated memory blocks.
